(19) United States
(12) Patent Application Publication
(10) Pub. No.: US 2010/0134263 A1
(43) Pub. Date: Jun. 3, 2010

(54) Method and apparatus for avoiding rear-end collisions

(76) Inventors: Hans-Joerg Mathony, Tamm-Hohenstange (DE); Alfred Kuttenberger, Herrenberg (DE); Mario Kroeninger, Buehl (DE); Dirk Meister, Moeglingen (DE); Michael Bunse, Vaihingen/Enz (DE); Stephan Spaeth, Ludwigsburg (DE)

Correspondence Address: KENYON & KENYON LLP, ONE BROADWAY, NEW YORK, NY, 10004, US

(21) Appl. No.: 11/988,907

(22) PCT Filed: Jun. 8, 2006
(86) PCT No.: PCT/EP2006/063018

§ 371 Date: Feb. 19, 2010

(30) Foreign Application Priority Data
Jul. 15, 2005 (DE) 10 2005 033 087.8

(51) Int. Cl. B60Q 1/00

(52) U.S. Cl. 340/435

(57) ABSTRACT

The invention relates to a method and a device for preventing rear end collisions with a vehicle. According to the invention, the distance (d) and/or speed (vrel) of the vehicle in relation to the vehicle in front are determined by means of an environmental sensor (2) oriented towards the front region of the vehicle. In the event of a stopping situation, a longitudinal dynamic value (alphaFP, alpha BP) initiated by the driver is evaluated in order to determine whether there is a risk of collision for the two vehicles in question. In the event of a risk of collision, the drive train (10) and/or the delay devices (11) of the vehicle are engaged in order to reduce the risk of collision and/or driver warning devices (12, 5) are triggered in order to inform the driver about the risk of collision.

### FIELD OF THE INVENTION

The present invention relates to a method and an apparatus for avoiding rear-end collisions upon initial movement behind a vehicle located in front, the distance and/or speed relative to the vehicle in front being ascertained by way of a surrounding-area sensor apparatus directed into the area in front of the vehicle and, when an initial-movement situation exists, a driver-actuated longitudinal dynamics stipulation being evaluated as to whether a risk of collision by the host vehicle with the vehicle in front exists, and when a collision risk exists, an intervention being made in the drive train and/or the deceleration devices of the vehicle in order to decrease the collision risk, and/or driver warning devices being activated to inform the driver as to the collision risk.

### BACKGROUND INFORMATION

German Published Patent Application No. 102 18 017 discloses a method for speed and separation control in motor vehicles in which the distance of a preceding vehicle is measured and at least two operating modes, activatable in different speed ranges that overlap one another, are provided for separation control, and in which the switchover between these operating modes, at least in one direction, is possible only by way of a driver instruction, the speed of the preceding vehicle being extrapolated into the future on the basis of the speed of the host vehicle and the measured separation data and/or relative speed data; and that a switchover request is outputted to the driver when the extrapolated speed lies outside the permissible range for the current mode and the current speed lies within the permissible range for the other mode.

### SUMMARY

Example embodiments of the present invention provide a method and an apparatus with which the risk of rear-end collisions upon initial movement behind a vehicle located in front are avoided by the fact that a collision risk is ascertained and, as a function of the degree of collision risk, an intervention is made in the drive train and/or the deceleration devices of the vehicle in order to avoid excessive acceleration of the vehicle, and the driver is informed by way of a driver warning device as to the elevated collision risk. An initial-movement situation can be detected by the fact that the vehicle located in front has been recognized as stationary by way of the surrounding-area sensor apparatus, and an acceleration of the host vehicle is measured in subsequent measurement cycles. By an evaluation of the longitudinal dynamics stipulations of the driver, which evaluation is derived from the instantaneous accelerator pedal actuation angle and the instantaneous brake pedal actuation angle, a collision risk can be determined with the aid of the instantaneous distance d and instantaneous relative speed vᵣₑₗ. In this case an intervention is made in the drive train control system, for example by reparameterizing the accelerator pedal characteristic curve, so that for a specific accelerator pedal actuation angle α_{FP}, an acceleration request is outputted which is less than is allocated to that angle α_{FP} in ordinary vehicle operation. This results in a lesser acceleration request to the vehicle, with the result that in the context of an elevated collision risk the vehicle is accelerated less than the driver is accustomed to based on ordinary vehicle operation. The intervention in the deceleration devices of the vehicle can be configured in such a way that a brake pressure buildup of the wheel brakes is automatically built up and controlled so that the vehicle acceleration is simultaneously braked by the driver's accelerator pedal actuation in order to prevent excessive acceleration of the host vehicle in the context of an elevated collision danger. The automatic brake pressure buildup can furthermore, in the context of initial movement on a upward slope, prevent the host vehicle from rolling backward if the driver does not actuate the accelerator pedal in timely fashion or if the vehicle accelerates less strongly than the driver is accustomed to from other driving situations, since the accelerator pedal characteristic curve is simultaneously reparameterized. The driver can furthermore be informed as to the elevated collision risk by the fact that, for example, acoustic or optical warning devices are activated, or by the fact that, for example, an accelerator pedal having an active return force is used, in which the resistance force of the accelerator pedal is electrically controllable. In the event of an elevated collision risk, it is possible in this context to increase the return force F_{FP} of the accelerator pedal so that the driver perceives an elevated counterpressure at the accelerator pedal, whereupon he or she intuitively decreases the accelerator pedal actuation angle α_{FP} so that the collision risk is diminished. According to example embodiments of the present invention, this is achieved by the features described herein. Advantageous refinements and example embodiments are described below.

Advantageously, an initial-movement situation is detected when the host vehicle is accelerating from a standstill and the host vehicle speed is below a predetermined limit speed.

It is additionally advantageous that the surrounding-area sensor apparatus is an ultrasonic sensor, a radar sensor, a lidar sensor, a photonic mixing device (PMD) sensor, a video sensor, or a combination of these sensor types.

It is additionally advantageous that the driver-actuated longitudinal dynamics stipulation is an accelerator pedal actuation and/or a release of the brake pedal.

Advantageously, the intervention in the drive train of the vehicle is accomplished by a modification of the accelerator pedal characteristic curve. The accelerator pedal characteristic curve, in this context, is the allocation of an acceleration request or an engine torque request as a function of the instantaneously established accelerator pedal actuation angle α_{FP}; in this initial-movement situation, the characteristic curve can be modified in such a way that for an identical accelerator pedal actuation angle α_{FP}, the acceleration request or engine torque request that is outputted is less than is provided in ordinary vehicle operation.

It is additionally advantageous that the intervention in the deceleration devices is accomplished by way of an automatic brake pressure buildup in order to make a collision-risking driver-actuated initial movement more difficult.

Advantageously, the intervention in the deceleration devices is accomplished by way of an automatic brake pressure buildup in order to prevent the host vehicle from rolling backward upon initial movement on a upward slope. Backward rolling of the host vehicle upon initial movement on an upward slope can be favored by the fact that the accelerator pedal characteristic curve has been reparameterized, so that for a specific accelerator pedal actuation angle α_{FP}, the acceleration request or engine torque request that is outputted is less than is provided in ordinary vehicle operation, with the result that upon initial movement on a hill, the acceleration or engine torque request that is actually requested can become so low, because of the reparameterization, that the host vehicle threatens to roll backward while the driver is unprepared therefor. In particular, a consequence of the combination of reparameterization of the accelerator pedal characteristic curve with automatic brake pressure buildup is that even in this initial-movement situation on an upward slope, the road user following behind is not endangered any more than without the system according to example embodiments of the present invention. In order to allow an initial movement on a hill to be detected, a longitudinal acceleration sensor can be provided which makes available a longitudinal acceleration signal aₓ. Optionally, it is also possible to use the longitudinal acceleration aₓ from a differentiation over time of the relative speed of objects that have been recognized by the surrounding-area sensor apparatus as stationary objects.

It is additionally advantageous that the driver warning is accomplished by way of an accelerator pedal having an electrically controllable return force, return force F_{FP} of the accelerator pedal being elevated in the context of an elevated collision risk. Accelerator pedals of this kind are already obtainable commercially and are known, inter alia, under the designation “force-feedback pedal.”

It is additionally advantageous that the driver warning device is provided an acoustic signaling device, for example in the form of a text output or in the form of a buzzer. In addition to the acoustic signaling device or as an alternative thereto, it is also possible to provide an optical driver warning device, for example by activating a warning light or outputting a clear-text output in the instrument panel display.

Advantageously, the driver can deactivate the collision avoidance function at any time by way of an accelerator pedal override.

It is additionally advantageous that the collision avoidance function is active only below an upper limit speed. A speed threshold between 10 km/h and 20 km/h is possible, for example, as an upper limit speed, since at higher speeds normal vehicle operation can be assumed and the initial-movement operation is complete.

It is additionally advantageous that the collision avoidance function is deactivated by a driver intervention in the drive train by way of an override of the accelerator pedal and/or a driver intervention in the deceleration devices by actuation of the brake pedal. The driver thereby has the capability of overriding this collision avoidance function at any time by a deliberate depression of the accelerator pedal or brake pedal, and continuing to operate the vehicle according to his or her individual stipulations.

It is particularly important that the method according to example embodiments of the present invention is realized in the form of a control element that is provided for a control unit of a separation control system or speed control system of a motor vehicle. A program that is executable on a control unit, in particular on a microprocessor or signal processor, and is suitable for carrying out the method according to example embodiments of the present invention, is stored on the control element. In this case, therefore, example embodiments of the present invention are realized by way of a program stored on the control element, so that the control element equipped with the program represents the invention in the same fashion as the method for whose performance the program is suitable. The control element used can be, in particular, an electrical storage medium, for example a read-only memory.

Further features, potential applications, and advantages of example embodiments of the present invention are evident from the description below of exemplary embodiments that are depicted in the drawings. All features described or depicted, of themselves or in any combination, constitute the subject matter hereof, irrespective of their grouping their internal references, and irrespective of their presentation and depiction in the description and the drawings, respectively.

Exemplary embodiments of the invention are explained below with reference to drawings.

### BRIEF DESCRIPTION OF THE DRAWINGS

FIG. 1 is a schematic block diagram of an example embodiment of the apparatus according to the present invention; and

FIG. 2 is a flow chart of an example embodiment of the method according to the present invention.

### DETAILED DESCRIPTION

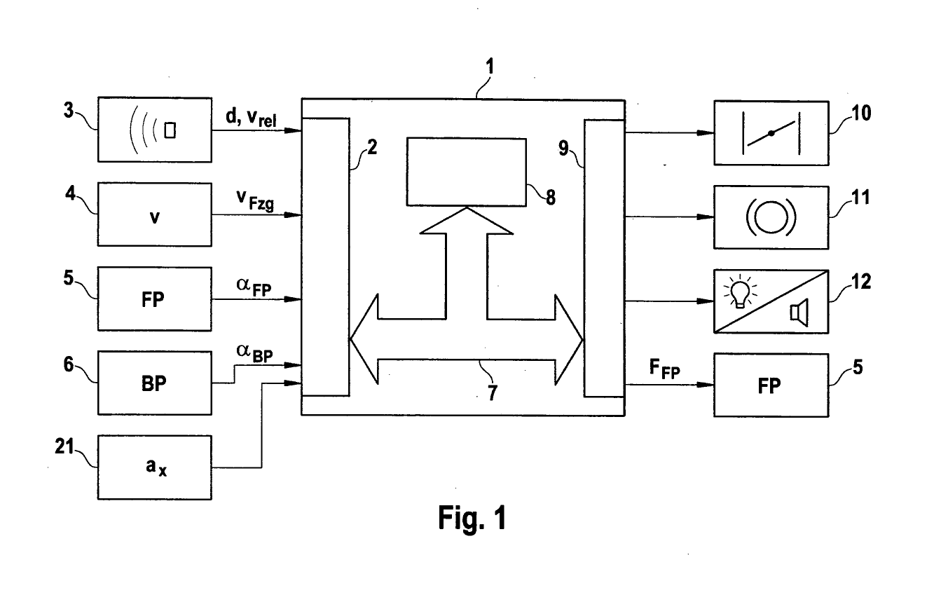

FIG. 1 is a schematic block diagram of an apparatus according to an example embodiment of the present invention, showing collision warning and avoidance device 1 which possesses an input circuit 2 by way of which input signals are deliverable to collision warning and avoidance device 1. Delivered to input circuit 2 as input signals are output signals of a surrounding-area sensor apparatus 3 that can be arranged, for example, as an ultrasonic sensor, radar sensor, lidar sensor, or video sensor, or as a combination of these sensor types. This surrounding-area sensor apparatus 3 is oriented in such a way that the front surrounding area of the vehicle is sensed and objects present therein, for example preceding moving vehicles or stopped vehicles located in front, are detected, and their distance d from the host vehicle, and their relative speed vᵣₑₗ, are ascertained. It is also possible to use a sensor apparatus 3 that can ascertain an azimuth angle at which the object in front was detected. These object-related measured variables are conveyed by surrounding-area sensor apparatus 3 to input circuit 2. Additionally provided is a speed sensor 4 that senses the instantaneous speed of the host vehicle and delivers it also, as measured variable v_{vehicle} to input circuit 2 of collision warning and avoidance device 1. Delivered to input circuit 2 as a further input variable is accelerator pedal actuation angle α_{FP}, which indicates the extent to which accelerator pedal 5 has been deflected by the driver, and to which an acceleration request or an engine torque request can therefore be allocated. Also delivered to input circuit 2 is a brake pedal actuation angle α_{BP} of brake pedal 6, which indicates the extent to which the brake pedal has been deflected by the driver, or whether the driver is not at present actuating brake pedal 6. Provision can furthermore be made to deliver to input circuit 2, as a further input signal, longitudinal acceleration aₓ of the host vehicle, so that a stationary situation, or one of initial movement on an upward slope, can be recognized. A longitudinal acceleration sensor 21 can be provided for this purpose. Alternatively, however, this information can also be ascertained by differentiation over time of the relative speed of stationary objects, for example at the roadside, by way of the surrounding-area sensor apparatus. The input signals delivered to input circuit 2 are delivered by way of a data exchange device 7 to a calculation device 8 that can be arranged, for example, as a microprocessor. Calculation device 8 contains a program that executes the method according to example embodiments of the present invention in the form of control data and calculates, as a function of the input signals delivered to input circuit 2, output signals that are outputted to downstream adjusting devices. These output signals are outputted from calculation device 8, via data exchange device 7, to an output circuit 9 to which the downstream adjusting members are connected. Provided as an adjusting element that influences the drive train of the vehicle is a power-determining adjusting element 10 of an internal combustion engine, which element can be arranged, for example, as an electrically controllable throttle valve or as a fuel quantity metering device in the form of an injection valve, and correspondingly regulates the internal combustion engine as a function of the acceleration request or engine torque request requested by the driver. Provided as a further adjusting element is deceleration device 11 of the vehicle, which device possesses e.g. an electrically controllable brake booster and converts an adjusting signal outputted by output circuit 9 into a corresponding brake pressure or a vehicle deceleration, and the vehicle performs a deceleration either as a function of brake pedal actuation angle α_{BP} or automatically irrespective of a driver actuation. It is possible in this fashion for collision warning and avoidance device 1 to intervene in deceleration devices 11 of the vehicle. Provided as a further adjusting element is a driver warning device 12 that can be arranged, for example, as an acoustic and/or optical signal device, for example in the form of an illuminating warning light, a clear-text indication in the display of the vehicle instrument panel, or a warning buzzer, or in the form of a computerized text output via a loudspeaker. As a further possibility for informing the driver as to an elevated collision risk, an active accelerator pedal 5 can be provided which can generate an electrically controllable return force, with the result that the counterforce of the pedal against the driver's foot is adjustable. By outputting an adjusting signal F_{FP} through output circuit 9, it is possible to adjust the return force of accelerator pedal 5 accordingly, and thereby to signal to the driver that he or she should actuate the accelerator pedal less strongly. It is thereby possible not only to inform the driver acoustically or optically by way of signaling device 12, but also, alternatively or additionally, to influence the driver intuitively by way of the pressure sensation in his or her foot in order to report a collision risk and decrease the collision risk.

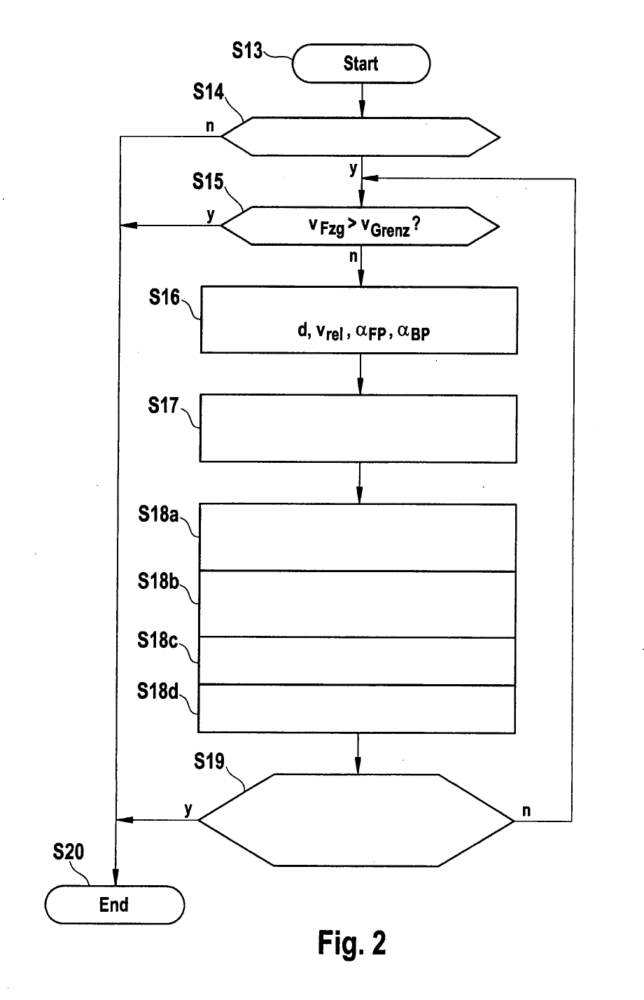

FIG. 2 is a flow chart of the method according to an example embodiment of the present invention. This method starts at step S13 and continues in step S14, which checks whether an initial-movement situation has been recognized. The initial-movement situation can be recognized by the fact that a vehicle which is located in front and is at a standstill has been detected by surrounding-area sensor apparatus 3. If it is then determined that the host vehicle is being accelerated, for example by a request for engine torque, and is no longer at a standstill, an initial-movement situation is then recognized and step S14 branches to “yes.” If an initial-movement situation is not recognized in step S14, the flow chart then branches to “no” and ends at step S20. If an initial-movement situation was recognized in step S14, the flow chart continues in step S15 by the fact that vehicle speed v_{vehicle} ascertained by speed sensor 4 is checked as to whether it is greater than a predetermined limit speed vₗᵢₘᵢₜ. Limit speed vₗᵢₘᵢₜ represents an upper speed threshold up to which the method is active. If the host vehicle speed v_{vehicle} is above the upper limit speed vₗᵢₘᵢₜ, which can be, for example, between 10 km/h and 20 km/h, it is then assumed that an initial-movement situation no longer exists and normal vehicle operation exists. If step S15 recognized that the instantaneous vehicle speed v_{vehicle} is greater than this limit speed vₗᵢₘᵢₜ, the method branches to “yes” and terminates at step S20. If a determination was made that vehicle speed v_{vehicle} is less than or equal to limit speed vₗᵢₘᵢₜ, the method then continues in step S16, in which the measured values for distance d from the host vehicle to the detected vehicle in front, relative speed vᵣₑₗ of the vehicle in front with reference to the host vehicle, the instantaneous accelerator pedal actuation angle α_{FP}, and the instantaneous brake pedal angle α_{BP} are ascertained and are processed in calculation device 8. By way of the accelerator pedal actuation angles α_{FP}, α_{BP} it is possible to establish whether the driver has released the brake pedal and is actuating the accelerator pedal, i.e. wishes to perform a host vehicle initial-movement operation, and how much he or she wishes to accelerate the host vehicle for initial movement, and how rapidly the preceding vehicle is moving away, by evaluating distance d and relative speed vrel. From the values with reference to the vehicle dynamics of the vehicle in front, and from the driver request signals α_{FP} and α_{BP}, in the next step S17 a collision risk is calculated, for example by calculating how much time still remains until a possible collision with the vehicle in front would occur if the host vehicle continued to be operated with the instantaneous acceleration requests. It is also possible, however, to detect a collision risk using different algorithms, for example also by storing multidimensional tables that allocates corresponding collision-risk values to the corresponding measured values d, vᵣₑₗ, α_{FP}, and α_{BP}. In the next step S18, multiple actions S18a to S18d are listed; depending on the arrangement, only one of these actions S18a to S18d can be carried out, any combination of these actions can be carried out, or all the actions S18a to S18d described can be carried out together. According to S18a, for example, provision is made for the accelerator pedal characteristic curve to be reparameterized as a function of the collision risk ascertained in step S17, so that in the context of a specific accelerator pedal actuation angle α_{FP}, an acceleration request or engine torque request is outputted that is less than in the context of the same accelerator pedal actuation angle α_{FP} in conventional vehicle operation. According to step S18b it is possible, alternatively or in combination with step S18a, to build up an automatic brake pressure buildup as a function of the collision risk calculated in step S17, so that the vehicle experiences less acceleration as a result of the driver's accelerator pedal actuation because vehicle deceleration devices 11 are acting against the acceleration input or, in the context of initial movement on an upward slope, backward rolling of the host vehicle is avoided. According to step S18c, which can be provided alternatively to steps S18a and S18b or in any combination with them, output of a driver warning is provided by the fact that an acoustic and/or optical signal device 12 informs the driver that the collision risk exists. According to step S18d it is possible, optionally or alternatively to steps S18a to A18c already described, to output a setpoint F_{FP} that represents an accelerator pedal return force with which the active accelerator pedal presses against the driver's foot in order to signal to the driver that he or she needs to deflect accelerator pedal 5 less than he or she is currently doing in order to diminish the existing collision risk that was calculated according to step S17. The subsequent step S19 checks whether the driver is reacting to the existing collision risk by way of an accelerator pedal actuation or a brake pedal actuation, and wishes to override the system by way of a large acceleration input or a large deceleration input, and thus wishes to override the collision warning and avoidance device. If step S19 has recognized that a driver override is present, step S19 branches to “yes” and the method is terminated at step S20, thus transitioning to normal vehicle operation. If step S19 recognizes that a driver override input is not present, step S19 branches to “no” and the method jumps back to step S15, which once again checks whether the activation condition—that the host vehicle speed v_{vehicle} must not be greater than the predetermined limit speed vₗᵢₘᵢₜ—exists, and the method is executed again, so that the output values for implementation of the actions according to steps S18a to S18d can be adjusted to the new driving situation using newly acquired measured values d, vᵣₑₗ, α_{FP}, α_{BP}.

1-14. (canceled)

15. An apparatus for avoiding rear-end collisions upon initial movement behind a vehicle located in front, comprising:
ascertaining at least one of (a) a distance and (b) a speed relative to the vehicle in front by a surrounding-area sensor apparatus directed into an area in front of a host vehicle;
when an initial-movement situation exists, evaluating a driver-actuated longitudinal dynamics stipulation as to whether a risk of collision by the host vehicle with the vehicle in front exists;
when a collision risk exists, at least one of (a) intervening in at least one of (i) a drive train and (ii) deceleration devices of the host vehicle in order to decrease the collision risk and (b) activating driver warning devices to inform a driver as to the collision risk.

16. The apparatus according to claim 15, wherein an initial-movement situation is recognized by an actuation of an accelerator pedal by the driver.

17. The apparatus according to claim 15, wherein an initial-movement situation is recognized only when the host vehicle speed is below a predetermined limit speed.

18. The apparatus according to claim 15, wherein the surrounding-area sensor apparatus includes at least one of (a) an ultrasonic sensor, (b) a radar sensor, (c) a lidar sensor, and (d) a video sensor.

19. The apparatus according to claim 15, wherein the driver-actuated longitudinal dynamics stipulation includes at least one of (a) an accelerator pedal actuation and (b) a release of a brake pedal.

20. The apparatus according to claim 15, wherein the intervention in the drive train includes modification of an accelerator pedal characteristic curve.

21. The apparatus according to claim 15, wherein the intervention in the deceleration devices includes an automatic brake pressure buildup in order to make a collision-risking driver-actuated initial movement more difficult.

22. The apparatus according to claim 15, wherein the intervention in the deceleration devices includes an automatic brake pressure buildup in order to prevent the host vehicle from rolling backward on a upward slope.

23. The apparatus according to claim 15, wherein the driver warning device includes an accelerator pedal having an electrically controllable return force, the return force of the accelerator pedal being elevated in the context of an elevated collision risk.

24. The apparatus according to claim 15, wherein the driver warning device includes an acoustic signaling device.

25. The apparatus according to claim 15, wherein the collision-avoidance function is deactivatable by an accelerator pedal override.

26. The apparatus according to claim 15, wherein the collision-avoidance function is active only below an upper limit speed.

27. The apparatus according to claim 15, wherein the collision-avoidance function is deactivated by at least one of (a) a driver intervention in the drive train by an override of an accelerator pedal and (b) a driver intervention in the deceleration devices by actuation of a brake pedal.

28. A method for avoiding rear-end collisions upon initial movement behind a vehicle located in front, comprising:
a surrounding-area sensor apparatus configured to ascertain at least one of (a) a distance and (b) a speed relative to the vehicle in front;
a device configured to evaluate a driver-actuated longitudinal dynamics stipulation, as a function of the at least one of (a) the distance and (b) the speed relative to the vehicle in front, and when an initial-movement situation exists, as to whether a risk of collision by a host vehicle with the vehicle in front exists, and, when a collision risk exists, to at least one of (a) intervene in at least one of (i) a drive train and (ii) deceleration devices of the host vehicle in order to decrease the collision risk and (b) output a driver warning to inform a driver as to the collision risk.
